(19) United States
(12) Patent Application Publication
(10) Pub. No.: US 2023/0306486 A1
(43) Pub. Date: Sep. 28, 2023

(54) DISPLAY CONTROL METHOD, NON-TRANSITORY RECORDING MEDIUM, AND DISPLAY CONTROL DEVICE

(71) Applicant: CASIO COMPUTER CO., LTD., Tokyo (JP)

(72) Inventors: Hiroshi MOROHOSHI, Tokorozawa-shi (JP); Kentaro MARU, Tokyo (JP)

(73) Assignee: CASIO COMPUTER CO., LTD., Tokyo (JP)

(21) Appl. No.: 18/189,471

(22) Filed: Mar. 24, 2023

(30) Foreign Application Priority Data
Mar. 25, 2022 (JP) 2022-049316

(51) Int. Cl. G06Q 30/0601; G06T 11/60; G06F 3/0482; G06F 3/04845

(52) U.S. Cl. CPC G06Q 30/0621; G06T 11/60; G06F 3/0482; G06F 3/04845

(57) ABSTRACT

In a display control method in an information processing device including a processor, the processor controls a customization screen for performing customization processing of a target, the target including a plurality of components, each of the components having a plurality of variations, to be displayed on a display, acquires information relating to customization of the components or the variations in the target by the customization processing performed by a user as an action history or a purchase record, and controls a display order of the components in the customization screen for customizing the target to be changed based on the acquired action history or purchase record and the components to be displayed on the display.

### CROSS-REFERENCE TO RELATED APPLICATION

This application claims the benefit of Japanese Patent Application No. 2022-049316, filed on Mar. 25, 2022, the entire disclosure of which is incorporated by reference herein.

### FIELD OF THE INVENTION

This application relates generally to a display control method, a non-transitory recording medium, and a display control device.

### BACKGROUND OF THE INVENTION

Recent years, product sales systems in which, in order to meet various customer needs for a product, a user can customize specifications of the product and order the customized product have appeared. For example, in Unexamined Japanese Patent Application Publication No. 2006-195761, a sales system in which a user can select components and configure a customized product is disclosed.

### SUMMARY OF THE INVENTION

One aspect of a display control method according to the present disclosure is
a display control method, the display control method being performed by an information processing device including a processor, and
the display control method includes the processor:
controlling a customization screen for performing customization processing of a target, the target including a plurality of components, each of the components having a plurality of variations, to be displayed on a display;
acquiring information relating to customization of the components or the variations in the target by the customization processing performed by a user as an action history or a purchase record; and
controlling a display order of the components in the customization screen for customizing the target to be changed based on the acquired action history or purchase record and the components to be displayed on the display.

### BRIEF DESCRIPTION OF THE DRAWINGS

A more complete understanding of this application can be obtained when the following detailed description is considered in conjunction with the following drawings, in which:

FIG. 1 is a diagram illustrating an example of a configuration of a product customization system according to Embodiment 1;

FIG. 2 is a diagram illustrating an example of components of a wristwatch according to Embodiment 1;

FIG. 3 is a diagram illustrating an example of a functional configuration of an EC site device according to Embodiment 1;

FIG. 4 is a diagram illustrating an example of a screen for the Internet shopping of a customizable product at an EC site according to Embodiment 1;

FIG. 5 is a diagram illustrating an example of a screen displaying detail information of a product selected at the EC site according to Embodiment 1;

FIG. 6 is a diagram illustrating an example of a screen for customizing a product at the EC site according to Embodiment 1;

FIG. 7 is a diagram illustrating another example of the screen for customizing a product at the EC site according to Embodiment 1;

FIG. 8 is a diagram illustrating an example of a screen for customizing a triple band loop at the EC site according to Embodiment 1;

FIG. 9 is a diagram illustrating another example of the screen for customizing a triple band loop at the EC site according to Embodiment 1;

FIG. 10 is a diagram illustrating an example of component image information according to Embodiment 1;

FIG. 11 is a diagram illustrating an example of action history information according to Embodiment 1;

FIG. 12 is a diagram illustrating an example of purchase record information according to Embodiment 1;

FIG. 13 is a diagram illustrating an example of selection frequency information according to Embodiment 1;

FIG. 14 is a diagram illustrating an example of display order information according to Embodiment 1;

FIG. 15 is a flowchart of customization display processing according to Embodiment 1;

FIG. 16 is a first part of a flowchart of customization display processing according to Embodiment 2;

FIG. 17 is a second part of the flowchart of the customization display processing according to Embodiment 2;

FIG. 18 is a diagram illustrating a first example of memory contents in customization display processing according to Embodiment 2;

FIG. 19 is a diagram illustrating a second example of the memory contents in the customization display processing according to Embodiment 2;

FIG. 20 is a diagram illustrating a third example of the memory contents in the customization display processing according to Embodiment 2;

FIG. 21 is a diagram illustrating an example of a screen for setting preferential conditions at an EC site according to Embodiment 3; and

FIG. 22 is a diagram illustrating an example of user information according to Embodiment 3.

### DETAILED DESCRIPTION OF THE INVENTION

A display control method and the like according to embodiments are described below with reference to the drawings. Note that, in the drawings, the same or equivalent constituent elements are designated by the same reference numerals.

Embodiment 1

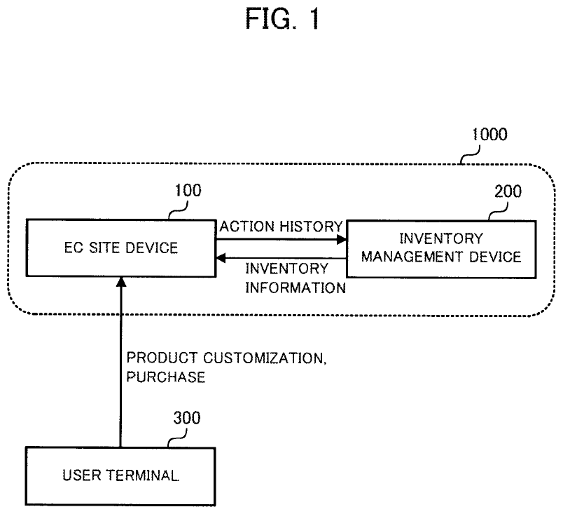

To facilitate understanding, the following description is made using a case where a display control method and the like according to Embodiment 1 are applied to a product customization system 1000 illustrated in FIG. 1 as an example. The product customization system 1000 includes, as illustrated in FIG. 1, an EC site device 100 and an inventory management device 200.

The EC site device 100 is a server to provide an EC site that sells customizable products. Each of the customizable products is composed of a plurality of components and is configured to be able to be customized by selecting each component from among a plurality of options (variations). Specifically, a user can, by accessing the EC site device 100 from a user terminal 300, such as a personal computer (PC) and a smartphone, and selecting a desirable one from among a plurality of variations with respect to each component, customize and purchase a product.

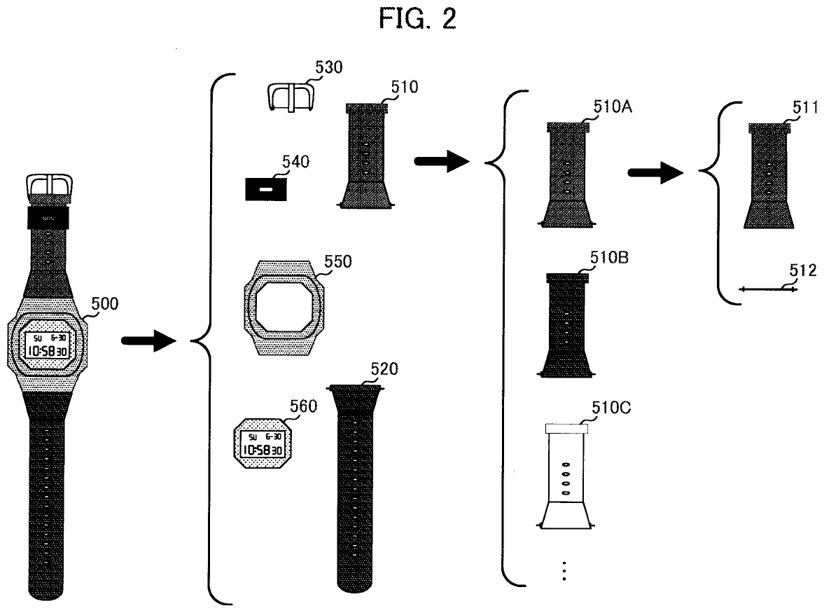

A customizable product and components and variations thereof are described using a wristwatch 500 illustrated in FIG. 2 as an example.

The wristwatch 500 is configured by combining a plurality of components, such as a short band component 510, a long band component 520, a buckle component 530, a band loop component 540, a bezel component 550, and a glass component 560.

For, for example, the short band component 510, a short band component 510A, a short band component 510B, a short band component 510C, and the like are prepared as variations in different colors. In addition, the short band component 510 includes two parts, namely a short band 511 and a band spring bar 512, and a plurality of variations is provided by combining short bands 511 of different colors with a band spring bar 512.

In other words, a variation (selectable specification) means, for example, a type of short band component 510 that is formed by changing color, material, the number of pieces, or the like of a part constituting the short band component 510. Specifically, a variation of a component is a different type of component in which properties (attributes), such as color, material, and the number of pieces, of a part are arbitrarily changed, such as the short band component 510A being a type of short band component 510 in which the color of the band is orange and the material of the band is a resin and the short band component 510B being another type of short band component 510 in which the color of the band is black and the material of the band is a metal. The number of variations can be arbitrarily chosen, and the number of variations of components does not have to be the same.

Although not illustrated, other components likewise include one or more parts, and a plurality of variations is provided by changing color, material, and the number of pieces of the parts.

Returning to FIG. 1, the EC site device 100 accumulates information about an action history of user actions that the EC site device 100 received from user terminals 300 (a history of views, selections, orders, or the like of products or components performed by users at the EC site) and a purchase record and sends the information to the inventory management device 200 as needed.

The inventory management device 200 grasps correspondences between components and parts and inventory statuses of respective parts, calculates inventory of components (the number of components that can be provided) based on the inventory of parts, and sends information about the inventory to the EC site device 100.

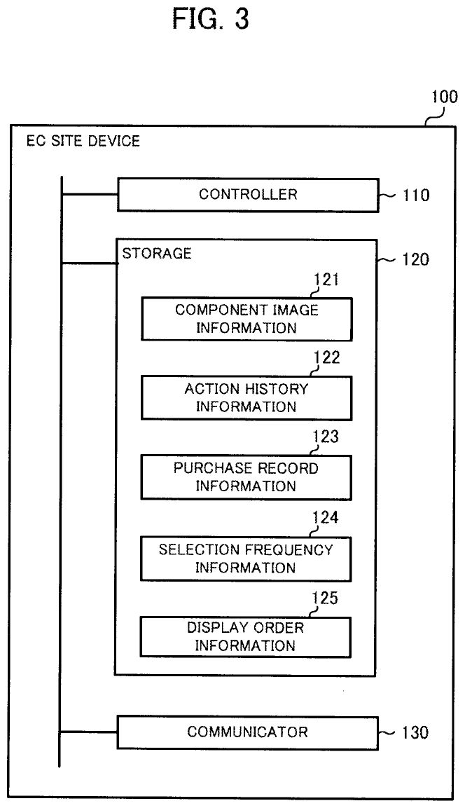

A functional configuration and the like of the EC site device 100 are described below. The EC site device 100 includes, as a functional configuration, a controller 110, a storage 120, and a communicator 130, as illustrated in FIG. 3.

The controller 110 includes a processor, such as a central processing unit (CPU). The controller 110 executes a program stored in the storage 120 and thereby causes the EC site device 100 to function as a web server of the EC site.

The storage 120 stores programs that the controller 110 executes and data required for the execution. The storage 120 may include a random access memory (RAM), a read only memory (ROM), a solid state drive (SSD), a hard disk drive (HDD), or the like, but not limited thereto.

The communicator 130 is a communication interface for the EC site device 100 to send and receive data to and from the inventory management device 200, the user terminal 300, and the like.

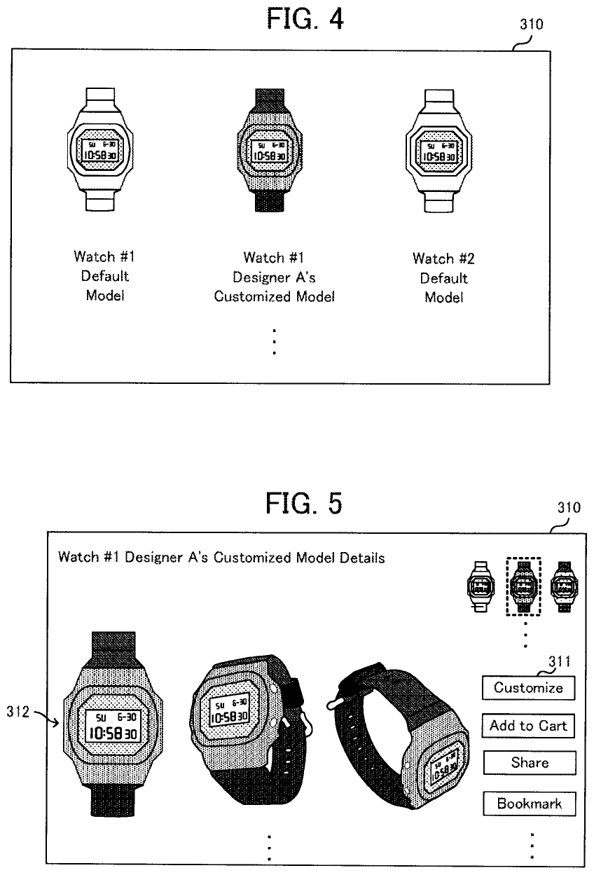

By including the functional configuration described above, the EC site device 100, when connected to a user terminal 300, provides a function of the EC site and causes a list of wristwatches that are purchasable through Internet shopping to be displayed on a screen 310 that is a display of the user terminal 300, as illustrated in, for example, FIG. 4.

In FIG. 4, as wristwatches with model number “Watch #1” (wristwatches of a base model #1), a “Default Model” that is not customized and a “Designer A's Customized Model” that is customized by designer A are displayed on the screen 310, and, as a wristwatch with model number “Watch #2” (a wristwatch of a base model #2), a “Default Model” that is not customized is displayed on the screen 310. Note that this is only an example of a displayed image. The EC site device 100 may, for example, display only wristwatches the model numbers of which are the same on the screen 310. In addition, the EC site device 100 may cause only a default model of a wristwatch with each model number to be displayed on an initial page of the EC site and cause customized models of each wristwatch to be displayed on another dedicated page.

When, on the screen 310 illustrated in FIG. 4, a user selects, for example, the “Watch #1 Designer A's Customized Model” (for example, clicks or taps a wristwatch that the user desires to select on the screen), the EC site device 100 causes a page displaying detail information about the selected product as illustrated in FIG. 5 to be displayed on the screen 310 of the user terminal 300. Although what type of information is displayed as detail information of a product can be arbitrarily chosen, a plurality of angled images 312 that is images of the selected wristwatch viewed from various angles (a plurality of lines of sight) is displayed in FIG. 5.

Although only three angled images 312 are displayed on the screen 310 illustrated in FIG. 5, angled images that allow, with respect to respective components that the user can select, the components to be effectively visually recognized may be prepared. In addition, angled images for confirming design of the entire product (for example, an overview image of the entire product viewed from the front, an overview image of the entire product viewed from the back, an image viewed from a lateral side, an image showing the product with a band wrapped, and the like) may be prepared. How many types of angled images 312 are prepared and from which angle an image to be used as an angled image 312 is captured can be arbitrarily chosen.

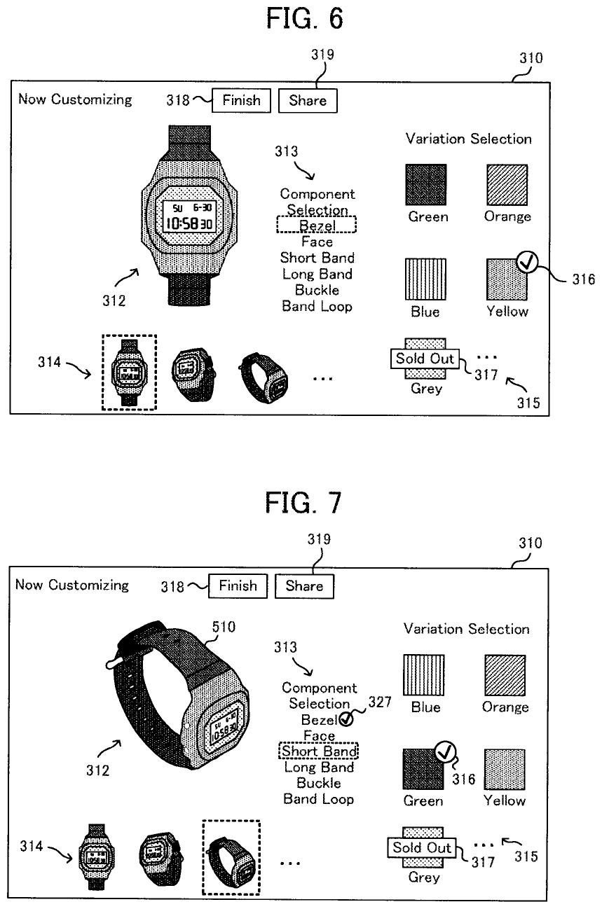

When the user presses a “Customize” button 311 (for example, clicks or taps the “Customize” button 311) located on the upper right side on the screen 310 illustrated in FIG. 5, the EC site device 100 causes a screen for customization (customization screen) for customizing each component of a product as illustrated in FIG. 6 to be displayed on the screen 310 of the user terminal 300 and accepts customization processing. FIG. 6 is an example of the screen for customization, and, in this example, a default angled image 312 (for example, an angled image viewed from the front) of a product to be customized is displayed comparatively largely on the center left side of the screen, and, under the default angled image 312, a list of selectable angled images 312 is displayed using thumbnail images 314 and, on the right side of the angled image 312, a list of customizable components 313 and a list of items 315 for customization (selectable variations) with respect to a selected component 313 are displayed.

While, in FIG. 6, options “Bezel”, “Face”, “Short Band”, “Long Band”, “Buckle”, and “Band Loop” are displayed in an area “Component Selection” as components 313, the options correspond to the bezel component 550, the glass component 560, the short band component 510, the long band component 520, the buckle component 530, and the band loop component 540, respectively. In FIG. 6, the bezel component 550 is being selected, and color options are displayed in such a way that a color can be selected as a selectable variation of the bezel component 550. As to the color options, colors that have been selected in the past are displayed in descending order of the number of selections as a list of items 315 for customization. In addition, a check mark 316 is displayed on a selected color option, and a “Sold Out” mark 317 is displayed on a color option that cannot be provided due to parts shortage (that is, being out of inventory).

When the user selects a color different from the color that is currently selected as an item 315 for customization of the bezel component 550, the color of the bezel component 550 of the wristwatch in the angled image 312 (effective angled image) on the screen 310 is changed to the selected color.

In addition, in the example illustrated in FIG. 6, a “Finish” button 318 and a “Share” button 319 are displayed in an upper portion of the screen. The user can select a variation with respect to a component that the user desires to customize and thereby customize a wristwatch on the screen for customization. When the customization is finished, the user can, by pressing the “Finish” button 318, finish the customization. After the customization is finished, the user can order the customized product. In addition, the user can, by pressing the “Share” button 319, post information about an image of the customized model to a social networking service (SNS) or the like.

In addition, when the user selects another component 313 that the user desires to customize from the list of components 313, the EC site device 100 considers that selection of a variation of a component 313 that has been selected up to that time (in this example, the bezel component 550) is finished and causes a check mark 327 to be displayed, and selects an angled image 312 that allows the selected another component 313 (in FIG. 7, the short band component 510) to be effectively visually recognized and causes the selected angled image 312 to be largely displayed on the screen 310, as illustrated in FIG. 7.

The EC site device 100 causes a list of items 315 for customization with respect to the selected component 313 to be displayed on the screen 310. In FIG. 7, color options are displayed in such a way that a color can be selected as a selectable variation of the short band component 510. The EC site device 100 causes colors that have been selected in the past to be displayed on the screen 310 in descending order of the number of selections as the list of items 315 for customization through customization display processing, which is described later.

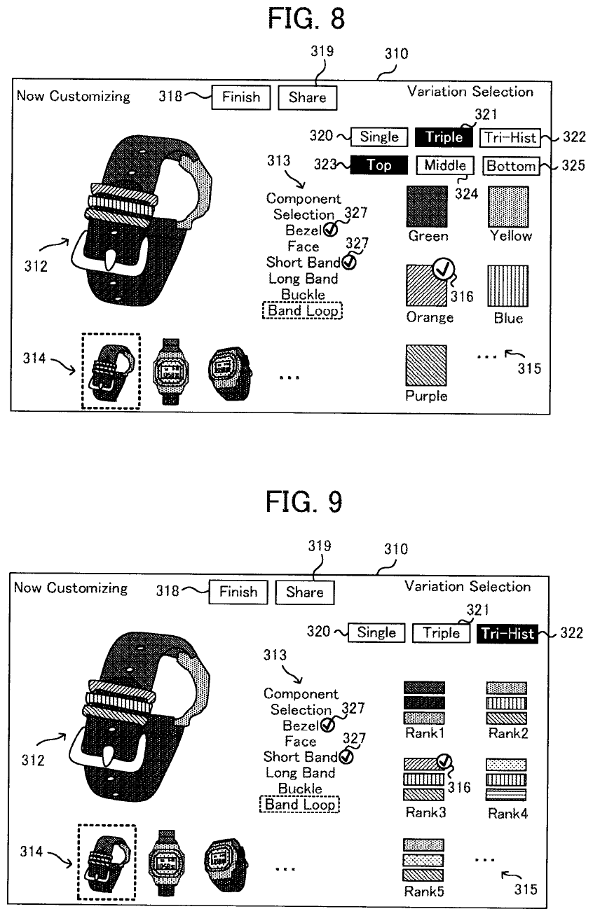

In addition, with respect to the band loop component 540 among the components, the user can, differing from the other components, select not only a color variation but also a band loop variation from between a single type (a regular band loop) and a triple type (triple band loops). The triple-type band loop component 540 includes three band loops, and the user can select a color for each of the three band loops. Therefore, when the user selects the “Band Loop” (the band loop component 540) as a component 313 in the component selection, the EC site device 100 causes, for example, a screen 310 for selecting a variation of the band loop component 540 as illustrated in FIG. 8 to be displayed.

In this screen, a “Single” button 320 to select the single type and a “Triple” button 321 to select the triple type as the band loop component 540 are prepared, and, when the “Triple” button 321 is pressed, a “Top” button 323, a “Middle” button 324, and a “Bottom” button 325 are further displayed to select one of the three band loops.

The “Top” button 323 is a button to select a variation of a band loop located at the top among the three band loops. The “Middle” button 324 is a button to select a variation of a band loop located at the middle among the three band loops. The “Bottom” button 325 is a button to select a variation of a band loop located at the bottom among the three band loops.

As described above, for the triple-type band loop component 540, the user is required to select a variation for each of the three band loops, which causes the selection operation to be complicated. Thus, the EC site device 100 may provide a function of causing combinations of colors of triple-type band loops that have been selected in the past to be displayed in descending order of the number of selections. In FIGS. 8 and 9, an example in which this function is provided is illustrated. When the user presses a “Triple History” button 322 on the screen illustrated in FIG. 8, the EC site device 100 causes combinations of three colors of triple-type band loops to be displayed in descending order of the number of times that a combination was selected starting from “Rank 1”, as illustrated in FIG. 9, and the user can select a variation of the triple-type band loop component 540 from among the combinations.

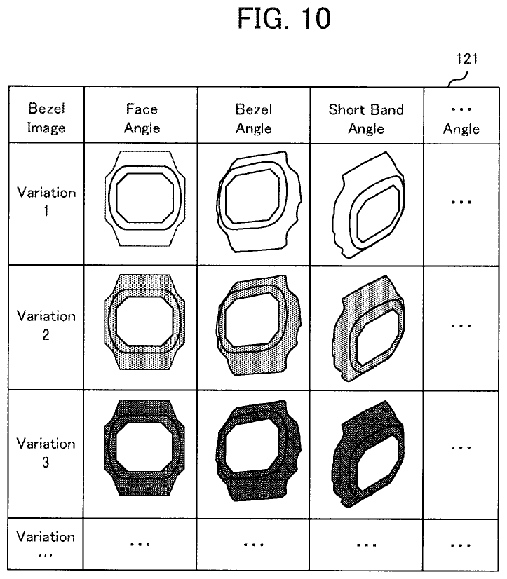

Returning to FIG. 3, various types of information that the storage 120 stores are described below. Component image information 121 is information about image materials (variation images) of respective variations with respect to each angle of each component. For example, as component image information 121 of the bezel component, image materials for respective angled images are stored with respect to each variation of the bezel component, as illustrated in FIG. 10. With respect to other components, similar component image information 121 is also stored in the storage 120.

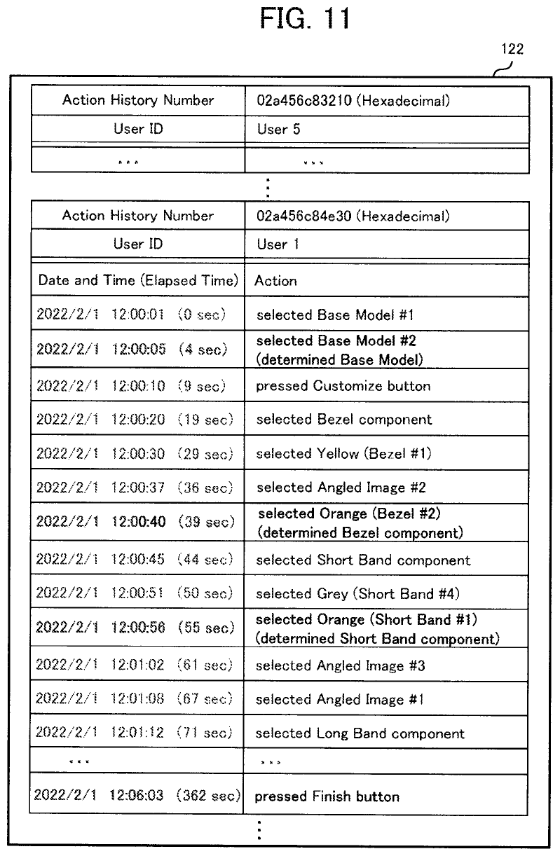

Action history information 122 is information about an operation history, such as which product and which component (variation) the user viewed at the EC site (how many times and how long the user viewed the product or the component), selected (how many times the user selected the product or the component), and ordered. Specifically, as illustrated in FIG. 11, the action history information 122 includes an “action history number” that is a number to uniquely identify action history information and a “user identification (ID)” that indicates for which user the action history was recorded and also includes a list of actions (viewing actions and selection actions) associated with dates and times.

In addition, in FIG. 11, with respect to a selection action that is the last selection action in the selection of a base model or a variation of each component, a description “(determined Base Model)” or “(determined xx component)” is added in parentheses in order to indicate that a base model or a variation of each component is determined by the selection action. However, since the controller 110 is capable of extracting the last selection of a base model or a variation of each component by tracking the action history information 122 from a point at which an action “pressed Finish button” was taken back to the past, the information in parentheses does not have to be included in the action history information 122.

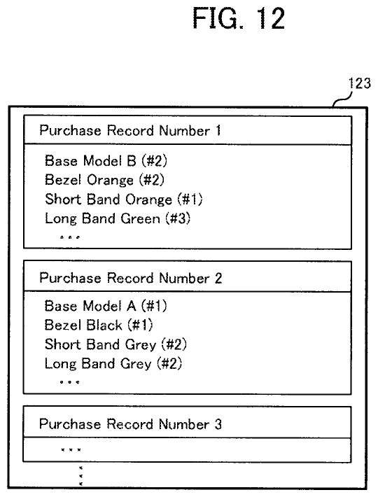

Purchase record information 123 is information indicating how an actually purchased product was customized. Specifically, as illustrated in FIG. 12, the purchase record information 123 includes a purchase record number (a number to uniquely identify purchase record information) and information about a base model and a selected variation of each component of a purchased product. Note that the purchase record information 123 may be included in and stored with the action history information 122.

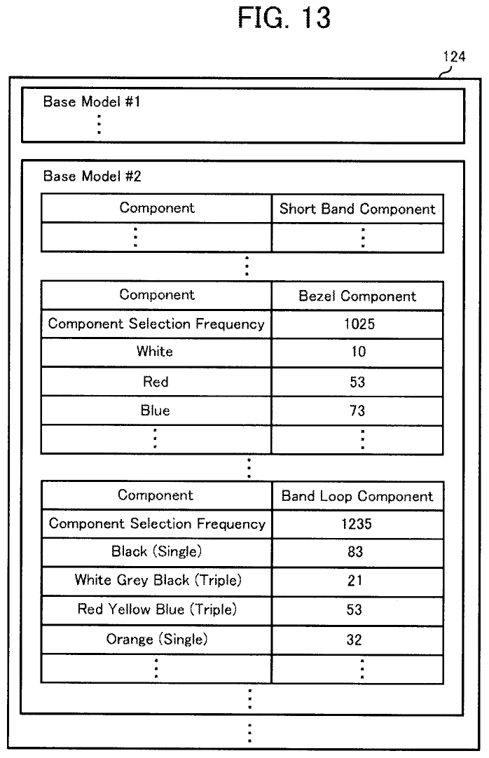

Selection frequency information 124 is information obtained by counting how many times each component or each variation of each component was selected by users at the time of customization. Specifically, as illustrated in FIG. 13, with respect to each base model, the number of times that each component was selected and the number of times that each variation of each component was selected at the time of customization of the base model are stored. The EC site device 100 may update the selection frequency information 124 every time a component or a variation is selected in the screen for customization or may acquire data in the selection frequency information 124 by calculating the numbers of selections of each component and each variation with reference to the action history information 122.

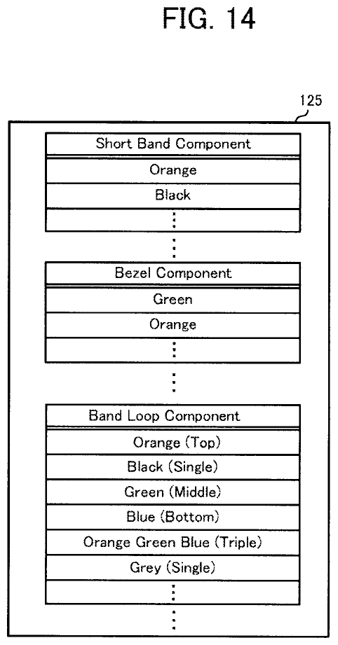

Display order information 125 is information indicating an order in which items 315 for customization (variations) for selecting a variation of each component are displayed on the screen for customization. Specifically, as illustrated in FIG. 14, with respect to each component, items 315 for customization (variations) of the component are recorded in accordance with an order in which the items 315 for customization (variations) are displayed. Although the items 315 for customization (variations) are recorded in a default display order in the beginning, the recording order is updated based on the selection frequency information 124 in the customization display processing, which is described later.

Although, in the display order information 125 illustrated in FIG. 14, with respect to the band loop component 540, a single type and a triple type coexist and, with respect to the triple type, a combination of three variations (“Triple”) and a variation for each position (“Top”, “Middle”, or “Bottom”) further coexist, this is because the numbers of selections of the respective variations are counted at the point of time when a variation of the band loop component 540 is determined and the variations are sorted in the order of the number of selections.

In this case, when, for example, the “Single” button 320 is pressed in the screen for customization illustrated in FIG. 8, only pieces of information about single-type variations are referred to in the display order information 125 and displayed in order as items 315 for customization, when the “Triple” button 321 is pressed, only pieces of information about variations corresponding to a selected position (“Top”, “Middle”, or “Bottom”) are referred to in the display order information 125 and displayed in order as items 315 for customization, and, when the “Triple History” button 322 is pressed, only pieces of information about triple-type variations are referred to in the display order information 125 and displayed in order as items 315 for customization, as illustrated in FIG. 9.

However, the display order information 125 illustrated in FIG. 14 is only an example, and may be configured in such a way that pieces of information are divided into pieces of information of single-type variations and pieces of information of triple-type variations and the pieces of information of single-type variations and the pieces of information of triple-type variations are separately stored. In addition, the display order information 125 may be further configured in such a way that, with respect to the triple-type variations, pieces of information are divided into pieces of information of variations of a “Top” band loop, pieces of information of variations of a “Middle” band loop, and pieces of information of variations of a “Bottom” band loop and the pieces of information of variations of “Top”, “Middle”, and “Bottom” band loops are separately stored.

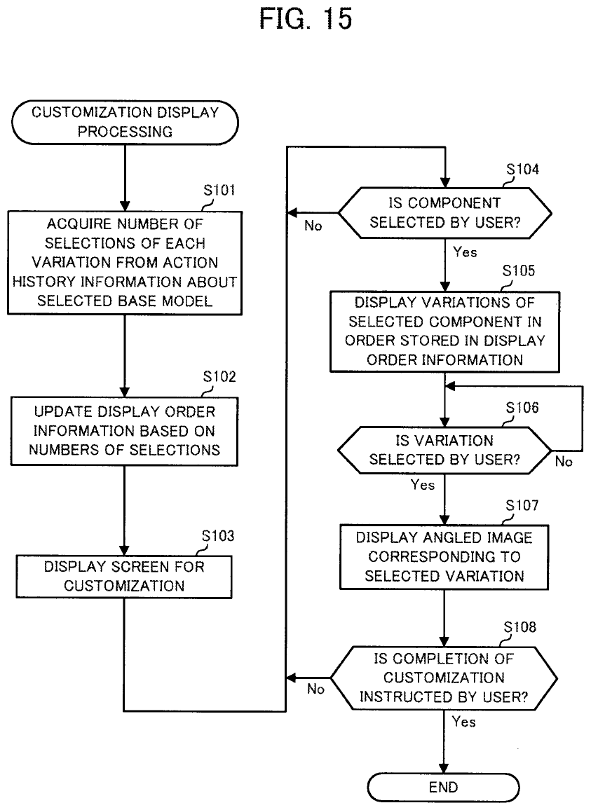

Next, with reference to FIG. 15, the customization display processing that the controller 110 of the EC site device 100 executes is described. This processing is executed when the screen for customization is displayed on a user terminal 300 that accessed the EC site provided by the EC site device 100. For example, when the “Customize” button 311 is pressed in the screen illustrated in FIG. 5, the customization display processing is executed and the screen for customization illustrated in FIG. 6 is displayed. The display order (display order information 125) in which items 315 for customization for causing a user to select a variation of each component are displayed on the screen for customization is determined (updated) by the customization display processing.

First, the controller 110 acquires the number of selections of each variation of each component with respect to a base model that was displayed (selected) on the screen 310 when the “Customize” button 311 was pressed (step S101). Specifically, the controller 110 acquires the number of selections of each variation from the action history information 122 with respect to the selected base model. For example, when the “Customize” button 311 was pressed while the base model #2 was selected, the controller 110 extracts pieces of action history information 122 in which actions were taken while the base model #2 was determined as the base model and acquires the number of selections by counting selection actions to select each variation of each component included in the extracted pieces of action history information 122. However, when updated values are constantly stored in the selection frequency information 124, the controller 110 may directly acquire the selection frequency information 124 from the storage 120 in step S101.

Next, the controller 110 updates the display order information 125, based on the numbers of selections acquired in step S101 (step S102). For example, the controller 110 causes variations arranged in descending order of the number of selections with respect to each component to be stored in the storage 120 as the display order information 125.

Then, the controller 110 causes, for example, a screen for customization as illustrated in FIG. 6 to be displayed on the screen 310 of the user terminal 300 (step S103). Next, the controller 110 determines whether or not some component has been selected by the user (step S104). However, when, in the screen for customization, items 315 for customization of an initial component (in FIG. 6, the bezel component 550) are displayed from the beginning as illustrated in FIG. 6, the controller 110, after causing the screen for customization to be displayed in step S103, considers that the initial component (for example, the bezel component 550) is selected (the determination in step S104 results in Yes).

When no component has been selected (step S104; No), the controller 110 returns to step S104. When a component is selected (step S104; Yes), the controller 110 causes variations (items 315 for customization) of the selected component to be displayed on the screen 310 of the user terminal 300 in the order stored in the display order information 125 that was updated in step S102 (step S105).

Next, the controller 110 determines whether or not some variation (item 315 for customization) has been selected by the user (step S106). When no variation has been selected (step S106; No), the controller 110 returns to step S106. When a variation is selected (step S106; Yes), the controller 110 causes an angled image 312 and the like matching the selected variation to be displayed (step S107).

Then, the controller 110 determines whether or not completion of the customization has been instructed (that is, whether or not the “Finish” button 318 has been pressed) by the user (step S108). When the completion is instructed (step S108; Yes), the controller 110 terminates the customization display processing. When the completion has not been instructed (step S108; No), the controller 110 returns to step S104.

Since the customization display processing described above causes items 315 for customization (variations) of each component displayed on the screen for customization to be displayed in descending order of the number of times that a variation was selected up to that time, the items 315 for customization come to be displayed in descending order of possibility of being selected by a user. Therefore, the EC site device 100 is capable of causing variations of each component to be displayed in such a way that a user can easily select a variation.

Note that, although, when the band loop component 540 is selected in the screen for customization, the “Single” button 320 and the “Triple” button 321 are displayed as illustrated in FIG. 8, the controller 110 may consider that the “Single” button 320 was pressed at the beginning and cause items 315 for customization (variations) of a single-type band loop to be displayed in descending order of the number of selections as an initial screen for selecting a variation of the band loop component 540. In addition, when the number of selections of the triple-type band loop is larger than that of the single-type band loop (for example, in the display order information 125 illustrated in FIG. 14, the triple-type band loop is ranked higher than the single-type band loop in the display order of variations of the band loop component 540), it may be configured such that a selection screen of the triple-type band loop is displayed from the beginning as illustrated in FIG. 8.

In addition, although, in the above-described customization display processing, the controller 110 acquires the selection frequency information 124 by counting selection actions in the action history information 122 and causes items 315 for customization (variations) to be displayed in descending order of the number of selections, this process is only an example of a determination method of display order. The controller 110 may, for example, instead of counting the numbers of selections of all variations, count the number of selections with respect to only an item 315 for customization (variation) that was first selected for each component and cause items 315 for customization (variations) to be displayed in descending order of the number of selections counted in this way.

In addition, the controller 110 may, for example, by counting the number of times that each item 315 for customization (variation) was selected for each component in the purchase record information 123, cause items 315 for customization (variations) to be displayed in descending order of the number of times that a variation were selected for each component at the point of time when the product was purchased.

Embodiment 2

Although, in the above-described embodiment, the display order of items 315 for customization (variations) of each component is determined based on a selected base model, Embodiment 2 in which a display order of items 315 for customization (variations) of each component is determined by taking into consideration not only a selected base model but also subsequent selection of components is described below.

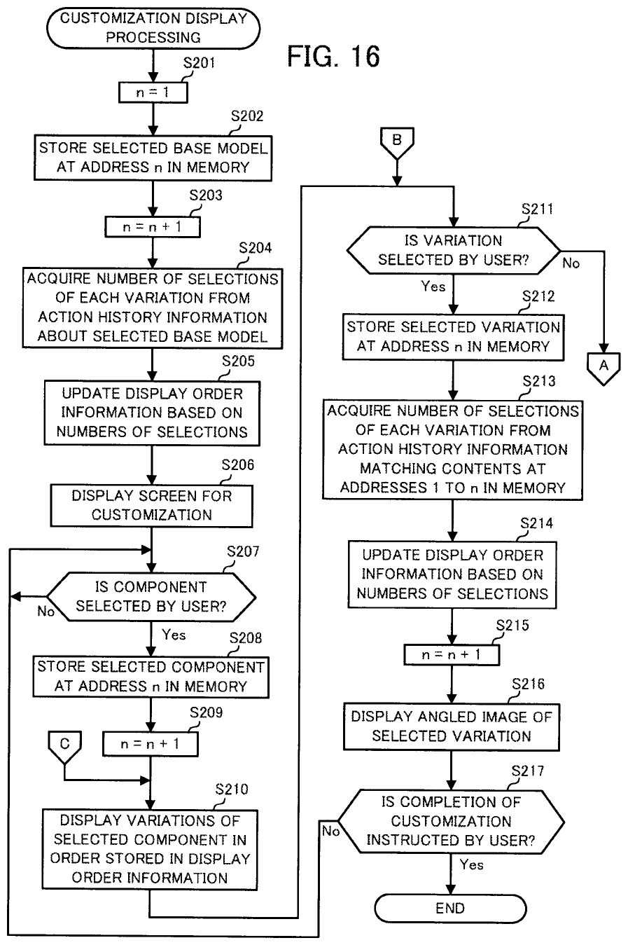

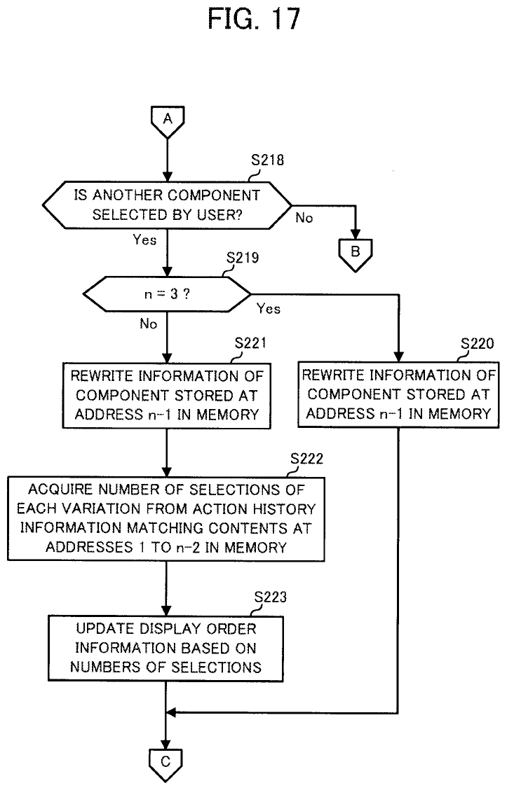

Since, although an EC site device 101 according to Embodiment 2 has a similar functional configuration to that of the EC site device 100 according to Embodiment 1, customization display processing according to Embodiment 2 is different from that in Embodiment 1, the customization display processing according to Embodiment 2 is described below with reference to FIGS. 16 and 17. This processing is also executed when a screen for customization is displayed on a user terminal 300 that accessed an EC site provided by the EC site device 101. That is, in Embodiment 2, when, for example, a “Customize” button 311 is pressed in a screen illustrated in FIG. 5, customization display processing that is described below is also executed and a screen for customization illustrated in FIG. 6 is displayed.

First, a controller 110 sets 1 in a variable n (step S201). The variable n is a variable that specifies an address (address in a memory of a storage 120) at which an option that a user selected is stored. However, the address is a virtual address for the purpose of description and does not have to correspond to a physical address, and can be considered as an index of an array variable in which names of base models, components, and items 315 for customization (variations) are stored.

Then, the controller 110 causes a name of a base model that was displayed (selected) on a screen 310 when the “Customize” button 311 was pressed to be stored at an address n in the memory (step S202). Next, the controller 110 adds 1 to the value of the variable n (step S203).

Since processing in steps S204 to S207 is the same as that in steps S101 to S104 in the customization display processing (FIG. 15) in Embodiment 1, a description thereof is omitted.

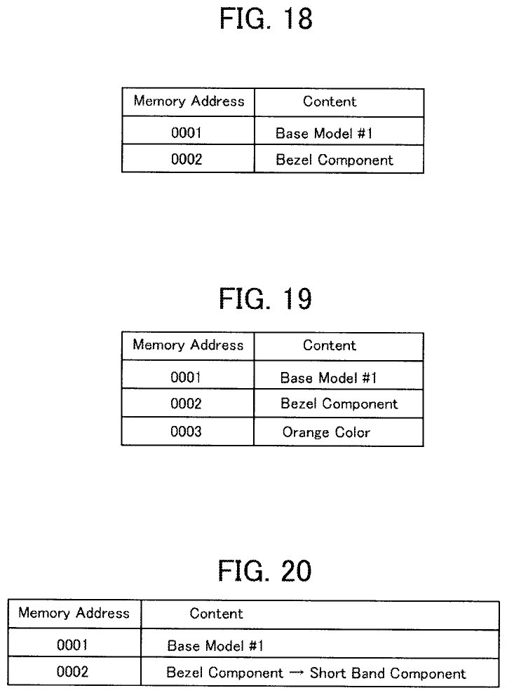

When a component is selected in step S207 (step S207; Yes), the controller 110 causes a name of the selected component to be stored at the address n in the memory (step S208). Then, the controller 110 adds 1 to the value of the variable n (step S209). When, for example, a base model #1 is selected, the customization display processing is executed, and subsequently a bezel component is selected, “Base Model #1” is written at an address 1 in step S202 and “Bezel Component” is written at an address 2 in step S208, as a result of which the memory has memory contents as illustrated in FIG. 18.

Then, the controller 110 causes variations (items 315 for customization) of the selected component to be displayed in an order stored in display order information 125 that was updated in step S205 (step S210).

Next, the controller 110 determines whether or not some variation (item 315 for customization) has been selected by the user (step S211). When no variation has been selected (step S211; No), the controller 110 proceeds to step S218 (FIG. 17). When a variation is selected (step S211; Yes), the controller 110 causes the selected variation to be stored at the address n in the memory (step S212). For example, when, in the case where the memory has the memory contents in FIG. 18, an orange bezel component 550 is selected as a variation, “Orange Color” is written at an address 3 in step S212, as a result of which the memory has memory contents as illustrated in FIG. 19.

Then, the controller 110 acquires the number of selections of each item 315 for customization (variation) from action history information 122 that matches contents at the addresses 1 to n in the memory (step S213). For example, when the memory has the memory contents illustrated in FIG. 19, the controller 110 extracts pieces of action history information 122 that include an action in which the base model #1 was determined as the base model and an action in which a variation of orange color was determined as the bezel component 550 from the action history information 122 and acquires the number of selections of each item 315 for customization (variation) by counting the number of times that each item 315 for customization (variation) of each component was selected in selection actions included in the extracted action history information 122.

Next, the controller 110 updates the display order information 125, based on the numbers of selections acquired in step S213 (step S214) and adds 1 to the value of the variable n (step S215). Then, the controller 110 causes an angled image 312 and the like matching the selected variation to be displayed (step S216).

Then, the controller 110 determines whether or not completion of the customization has been instructed by the user (step S217). When the completion is instructed (step S217; Yes), the controller 110 terminates the customization display processing. When the completion has not been instructed (step S217; No), the controller 110 returns to step S207.

In addition, in step S218 (FIG. 17), the controller 110 determines whether or not another component has been selected by the user. When no other component has been selected (step S218; No), the controller 110 returns to step S211 (FIG. 16).

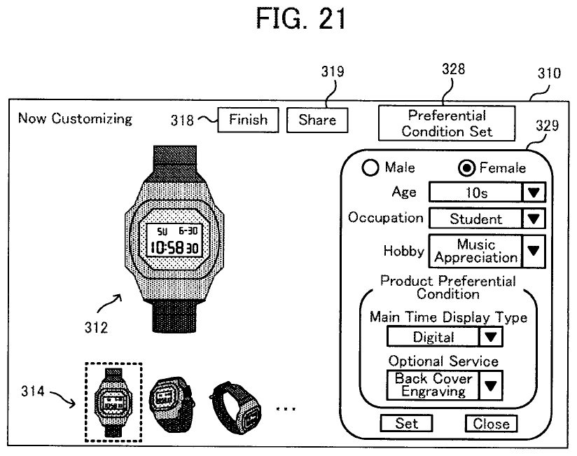

When another component is selected (step S218; Yes), the controller 110 determines whether or not the variable n has a value of 3 (step S219). When the variable n has a value of 3 (step S219; Yes), the controller 110 rewrites the name of a component having been stored at an address n-1 in the memory with the name of a component that is selected this time (step S220) and returns to step S210 (FIG. 16). For example, when, in the case where the memory has the memory contents illustrated in FIG. 19, a short band component 510 is selected as another component, the content at the address 2 is rewritten from “Bezel Component” to “Short Band Component” in step S220, as a result of which the memory has memory contents as illustrated in FIG. 20.

In contrast, when the variable n does not have a value of 3 (step S219; No), the controller 110 rewrites the name of a component having been stored at the address n-1 in the memory with the name of a component that is selected this time (step S221). Then, the controller 110 acquires the number of selections of each variation from pieces of action history information 122 that match contents at the addresses 1 to n-2 in the memory (step S222).

Note that the reason why the process is branched depending on whether or not the value of the variable n is 3 is that, while, when the variable n has a value other than 3 (an odd number of 5 or more), display order information of variations of a component that is selected this time (in step S218) is required to be changed, when the variable n has a value of 3, it is not required to change the display order information (display order information updated in step S205 can be used without change) because the selection of a component is a component selection immediately after the selection of a base model. When the variable n has a value other than 3, selections of variations have been performed with respect to one or more components up to that time and selected variations are stored at addresses up to an address n-2 in the memory. Therefore, processing for updating display order information of variations of a component that is selected this time, based on the information (selection sequence) is processing in steps S222 and S223.

Then, the controller 110 updates the display order information 125, based on the numbers of selections acquired in step S222 (step S223) and returns to step S210 (FIG. 16).

Through the customization display processing described above, a selection sequence that indicates an order in which respective components are selected is recorded at the addresses 1 to n (or the address n-2) in the memory, and the display order information 125 is updated based on pieces of action history information 122 the selection sequence of which coincides with the recorded selection sequence. That is, since, after taking into consideration not only the base model but also subsequent variation selection, variations of each component to be displayed on the screen for customization are displayed in descending order of the number of times that each variation was selected up to that time, the variations come to be displayed in descending order of possibility of being selected by a user. Therefore, the EC site device 101 is capable of causing variations of each component to be displayed in such a way that a user can easily select a variation.

Note that, although, in the above-described customization display processing, the controller 110 extracts pieces of action history information 122 that match memory contents, acquires the numbers of selections by counting selection actions, and causes items 315 for customization (variations) to be displayed in descending order of the number of selections, this process is only an example of a determination method of a display order. The controller 110 may, for example, instead of counting all the numbers of selections in action history information 122 that matches memory contents, count the number of selections with respect to only an item 315 for customization (variation) that was first selected for each component and cause items 315 for customization (variations) to be displayed in descending order of the number of selections counted in this way.

Embodiment 3

In the above-described embodiments, a display order of items 315 for customization (variations) of each component was determined, based on an action history and a purchase record of all users who accessed the EC site device 100 or 101. However, it is conceivable that a manner of customization differs depending on properties of a user (gender, age, occupation, hobby, characteristics of a product that the user desires to purchase, and the like). Thus, Embodiment 3 in which a display order is determined using an action history that matches properties of a user is described.

On a screen for customization of an EC site device 102 according to Embodiment 3, a “Preferential Condition Set” button 328 is displayed as illustrated in FIG. 21. When a user presses the “Preferential Condition Set” button 328, a preferential condition setting window 329 is displayed and the user is able to input preferential conditions at the time of customization.

In the example of the preferential condition setting window 329 illustrated in FIG. 21, the user can set gender, age, occupation, and hobby as properties of a person who is performing customization and also set a main time display form (digital or analog) and an optional service as properties of a product that the user desires to customize.

Although “Back Cover Engraving” is displayed as an optional service in FIG. 21, this optional service is a service of engraving a message, a symbol, or the like on the back cover of a wristwatch. As other optional services, the EC site device 102 is capable of providing a user with an arbitrary service (for example, band printing (a service of printing characters and a mark on the short band or the long band of a wristwatch), watch pedestal provision (a service of shipping a pedestal on which a design that is formed by using a design or colors that a user customized as motifs is printed in the same package with the watch), package design (a service of shipping an outer packaging box on which a design that is formed by using a design or colors that a user customized as motifs is printed in the same package with the watch), or the like).

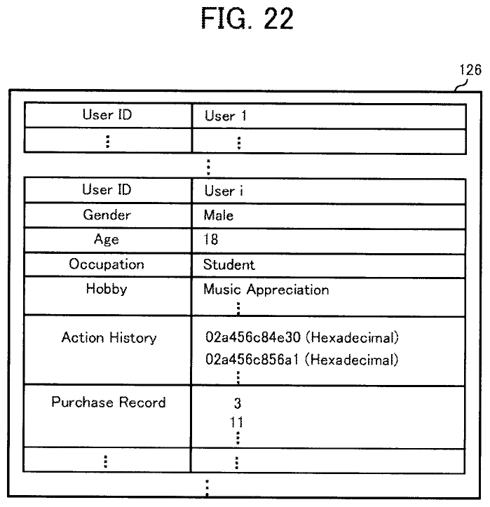

The EC site device 102 according to Embodiment 3 has a function of storing user information 126 as illustrated in FIG. 22 in a storage 120 in addition to the functional configuration of the EC site device 100 or 101 according to Embodiment 1 or 2. That is, a user who accessed the EC site device 102 according to Embodiment 3 registers property data (data on gender, age, occupation, hobby, characteristics of a product that the user desires to purchase, and the like) of the user at the start of use. A controller 110 stores property data of each user in the storage 120 as the user information 126 and subsequently stores action history information 122 and purchase record information 123 in association with the user information 126.

In customization display processing according to Embodiment 3, the controller 110 updates display order information 125, based on an action history and a purchase record of a user who matches conditions that the user input in the preferential condition setting window 329, that is, a user whom the property data matches. In addition, the controller 110 causes a product and a variation that match the product preferential conditions that the user input in the preferential condition setting window 329 to be displayed in a prioritized manner (by raising a display priority).

Specifically, the controller 110 extracts an action history number and a purchase record number of a user who matches conditions input in the preferential condition setting window 329 from the user information 126, calculates the numbers of selections of items 315 for customization (variations), based on pieces of action history information 122 indexed by the extracted action history number and pieces of purchase record information 123 indexed by the extracted purchase record number, and updates the display order information 125 in such a way that variations are displayed in descending order of the number of selections. The controller 110 updates the display order information 125 in such a way as to raise the display priority of, among items 315 for customization (variations) listed in the display order information 125, an item 315 for customization (variation) for a product matching the product preferential conditions that the user input in the preferential condition setting window 329 higher than an item 315 for customization (variation) for a product that does not match the product preferential conditions.

As described in the foregoing, the display order information 125 being updated causes an item 315 for customization (variation) that matches preferential conditions that the user set in the preferential condition setting window 329 to be displayed in a prioritized manner (by raising the display priority).

As described above, since, in the customization display processing according to Embodiment 3, items 315 for customization (variations) of each component are displayed by taking into consideration preferential conditions that a user set, the items 315 for customization (variations) come to be displayed in descending order of possibility of being selected by the user. Therefore, the EC site device 102 is capable of causing variations of each component to be displayed in such a way that a user can easily select a variation.

Embodiment 4

With regard to a manner in which candidates of items 315 for customization of each component are displayed, arranging the variations in such a way that variations with similar colors are placed close to one another enables a user to select an item 315 for customization (variation) while comparing colors that are finely different from one another. Embodiment 4 in which items 315 for customization with approximate colors are displayed side by side as described above is described below.

An EC site device 103 according to Embodiment 4 has a similar functional configuration to those of the EC site devices 100, 101, and 102 according to the above-described embodiments. However, in customization display processing according to Embodiment 4, a controller 110 displays the first variation (with the first display priority) among variations of each component stored in display order information 125 as the first item 315 for customization and subsequently displays other variations side by side in the order of hues starting from the first variation.

More specifically, the controller 110 calculates a hue value of the color of each selectable item 315 for customization (variation) of a component that is being selected and sorts the variations by the hue values (however, with regard to hue values, it is considered that a minimum value (for example, 0) succeeds a maximum value (for example, 1)). The controller 110 displays an item 315 for customization (variation) with a color that was most frequently selected at the top and subsequently displays other items 315 for customization in the order of closeness in hue values (in the sorted order).

Since displaying variations in this manner causes items 315 for customization (variations) with similar colors to be displayed close to each other, a user is enabled to easily compare colors that are finely different from one another and easily select an item 315 for customization (variation).

Embodiment 5

For a sales company selling a product that can be customized using an EC site device 100, it is preferable to prevent items 315 for customization (variations) of each component from being out of inventory as much as possible. Thus, Embodiment 5 in which items 315 for customization are displayed in an order determined by taking into consideration the amount of inventory is described below.

An EC site device 104 according to Embodiment 5 has a similar functional configuration to those of the EC site devices 100, 101, 102, and 103 according to the above-described embodiments. However, in customization display processing according to Embodiment 5, a controller 110 acquires the amount of inventory of each variation from an inventory management device 200 and updates display order information 125 in such a way that the variations are arranged in descending order of the amount of inventory. However, when variations that are stocked in the same amount exist, the controller 110 updates the display order information 125 in such a way that the variations stocked in the same amount are arranged in descending order of the number of selections.

Note that, although the controller 110 may, instead of updating the display order information 125 in such a way that variations are arranged in descending order of the amount of inventory, basically updating the display order information 125 in such a way that variations are arranged in descending order of the number of selections (as with the above-described embodiments), the controller may move the display priority of an item 315 for customization (variation) that is stocked in an amount of 0 or a value less than or equal to an insignificant threshold (for example, 3) toward the lowest priority.

Displaying items 315 for customization (variations) by taking into consideration the amount of inventory enables the EC site device 104 according to Embodiment 5 to, while preventing the variations from being out of inventory as much as possible, display the items 315 for customization (variations) in such a way that a user can easily select a variation.

Embodiment 6

In the above-described embodiments, basically, changing the display order of items 315 for customization (variations) of each component in the screen for customization enabled a user to easily select an item 315 for customization (variation). However, a target the display order of which is to be changed does not have to be limited to items 315 for customization (variations). Embodiment 6 in which the display order of selectable components 313 is also changed in a screen for customization is described below.

Although an EC site device 105 according to Embodiment 6 has a similar functional configuration to those of the EC site devices 100, 101, 102, 103, and 104 according to the above-described embodiments, not only a display order of items 315 for customization (variations) of each component but also a display order of components are stored in display order information 125.

In customization display processing according to Embodiment 6, a controller 110 acquires the number of selections of each component by counting selection actions of the components included in action history information 122 at the time of updating the display order information 125 and also updates the display order of the components, based on the numbers of selections of the components. The controller 110, when displaying selectable components 313 on the screen for customization, displays names of the components in a display order in accordance with the updated display order information 125.

Note that, with respect to components, the display order may be determined, instead of by the number of selections, by placing importance on a sequence of selections (for example, a variation of a bezel component 550 is first determined and a variation of a long band component 520 is next determined, or the like). In this case, the controller 110 counts pieces of information about selection sequences of respective components, based on the action history information 122, and updates information about the components in the display order information 125 in such a way that a component that has the largest number of times that the component was selected at the n-th position in the selection sequences is displayed at the n-th position in the component list.

In addition, since, to a component for which a variation is determined, a check mark 327 is attached as illustrated in FIGS. 7 and 8, the controller 110 may move the component in such a way that the component is displayed at the last position in the display order at the time of attaching the check mark 327 to the component. For example, in the case where the components are displayed in the order of “Bezel, Face, Short Band, Long Band, Buckle, Band Loop” at the beginning, the controller 110 changes the order to “Face, Short Band, Long Band, Buckle, Band Loop, Bezel” when attaching the check mark 327 to “Bezel”.

Changing a display order of selectable components 313 at the time of displaying the selectable components 313 as described above enables a user to easily perform not only selection of an item 315 for customization (variation) but also selection of a component.

Variations

Note that, although, in the above-described embodiments, it is assumed that a user accesses an EC site that the EC site device 100, 101, 102, 103, 104, or 105 provides from a user terminal 300 and customization processing is performed, the customization processing is not limited to such a form. For example, the customization processing may be configured to be executed by installing a dedicated application program for accessing the EC site without using a web browser in the user terminal 300 and accessing the EC site by the dedicated application program.

In addition, although, in the above-described embodiments, the description was made using a digital wristwatch as an example of a product model that a user can customize at the EC site, a target to be customized is not limited to a digital wristwatch. For example, in place of or in addition to a digital wristwatch, an analog watch or a combination watch of an analog watch and a digital watch (a watch that largely displays time on the face of the watch in analog form using an hour hand, a minute hand, and the like and, at the same time, forms an opening of an arbitrary size at an arbitrary position on the face of the watch and displays time and the like in digital form by a liquid crystal display or the like from the opening) may be set as a customizable product model. In addition, it may be configured such that, at the EC site, without being limited to a watch, an arbitrary target having a plurality of arbitrary components can be customized.

In addition, a target to be subjected to the customization processing is not limited to a tangible object. For example, a digital file, such as painting data, music data, and video data, that is identified by a non-fungible token (NFT) may serve as a target to be subjected to the customization processing. In addition, without being limited to data identified by an NFT, arbitrary data having an arbitrary customizable component can be set as a target of the customization processing.

Advantageous Effects and Others

Since the controller 110 changes the display order of components 313 or items 315 for customization in the screen for customization, based on an action history or a purchase record of users and causes the components 313 or the items 315 for customization to be displayed on the screen 310, a user is enabled to easily select a component.

In addition, since the controller 110 acquires property data indicating properties of a user, changes the display order of components 313 or items 315 for customization in the screen for customization, based on an action history or a purchase record of the user that matches the property data and causes the components 313 or the items 315 for customization to be displayed on the screen 310, a user is enabled to more easily select a component.

In addition, the controller 110 causes items 315 for customization to be displayed on the screen 310 in the order of hue values, the user is enabled to easily compare differences of colors of the items 315 for customization (variations).

In addition, since the controller 110 lowers the display priority of an item 315 for customization that is stocked in a small amount and causes the item 315 for customization to be displayed on the screen 310, it is possible to increase a probability that a user selects an item 315 for customization that is stocked in a large amount.

Note that the EC site devices 100, 101, 102, 103, 104, and 105 can also be achieved by a computer such as a general PC. Specifically, in the above-described embodiments, the description was made assuming that a program that the controller 110 in the EC site device 100, 101, 102, 103, 104, or 105 executes is stored in the storage 120 in advance. However, a computer capable of executing the above-described processing may be configured by storing and distributing a program in a non-transitory computer-readable recording medium, such as a flexible disk, a compact disc read only memory (CD-ROM), a digital versatile disc (DVD), a magneto-optical disc (MO), a memory card, and a USB memory, and reading and installing the program into the computer.

Therefore, the user terminal 300 may be caused to function as the EC site device 100, 101, 102, 103, 104, or 105 (display control device) by causing the user terminal 300 to store a program and data similar to those of the EC site device 100, 101, 102, 103, 104, or 105. In addition, it may be configured such that the user terminal 300 and the EC site device 100, 101, 102, 103, 104, or 105 divide required data and respectively store the divided data and the above-described customization display processing is executed through collaboration between the controller of the user terminal 300 and the controller 110 of the EC site device 100, 101, 102, 103, 104, or 105.

Further, it is also possible to superimpose a program on a carrier wave and apply the program via a communication medium, such as the Internet. For example, the program may be posted on a bulletin board system (BBS) on a communication network and distributed via the communication network. It may be configured such that the above-described processing can be executed by starting up and executing the distributed program in a similar manner to other application programs under the control of the operating system (OS).

In addition, the controller 110 may be configured not only by an arbitrary processor, such as a single processor, multiple processors, and a multi-core processor, alone but also by combining such an arbitrary processor and a processing circuit, such as an application specific integrated circuit (ASIC) and a field-programmable gate array (FPGA).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display control method, the display control method being performed by an information processing device including a processor, the display control method comprising the processor:
controlling a customization screen for performing customization processing of a target, the target including a plurality of components, each of the components having a plurality of variations, to be displayed on a display;
acquiring information relating to customization of the components or the variations in the target by the customization processing performed by a user as an action history or a purchase record; and
controlling a display order of the components in the customization screen for customizing the target to be changed based on the acquired action history or purchase record and the components to be displayed on the display.

2. The display control method according to claim 1, wherein the display order of the components is a display order of the variations for selecting the variation with respect to each component in the customization screen.

3. The display control method according to claim 1, wherein the action history of the user is a history of selections of the variations by the user.

4. The display control method according to claim 3, wherein the processor raises a display priority of the variation that was selected a large number of times, based on the action history.

5. The display control method according to claim 4, wherein the processor raises a display priority of the variation that was selected a large number of times in an action history in which a selection sequence that indicates a sequence in which the components are selected coincides with the selection sequence of the user.

6. The display control method according to claim 1, wherein the processor
acquires property data that indicate a property of the user, and
controls a display order of the components in the customization screen for customizing the target to be changed based on an action history or a purchase record of the user that matches the property data and the components to be displayed.

7. The display control method according to claim 1, wherein the processor, when the variations are variations with respect to color, controls the variations to be displayed in descending order of hue values starting from a variation of a color having a highest display priority.

8. The display control method according to claim 1, wherein the processor lowers a display priority of the variation that is stocked in a small amount.

9. The display control method according to claim 1, wherein the target is a watch.

10. A non-transitory computer-readable recording medium recording a program that is executable by a processor of an information processing device including the processor, the processor executing, in accordance with the program:
controlling a customization screen for performing customization processing of a target, the target including a plurality of components, each of the components having a plurality of variations, to be displayed on a display;
acquiring information relating to customization of the components or the variations in the target by the customization processing performed by a user as an action history or a purchase record; and
controlling a display order of the components in the customization screen for customizing the target to be changed based on the acquired action history or purchase record and the components to be displayed on the display.

11. A display control device, the display control device including a processor, the processor:
controlling a customization screen for performing customization processing of a target, the target including a plurality of components, each of the components having a plurality of variations, to be displayed on a display;
acquiring information relating to customization of the components or the variations in the target by the customization processing performed by a user as an action history or a purchase record; and
controlling a display order of the components in the customization screen for customizing the target to be changed based on the acquired action history or purchase record and the components to be displayed on the display.
